(19) United States
(12) Patent Application Publication
(10) Pub. No.: US 2026/0082316 A1
(43) Pub. Date: Mar. 19, 2026

(54) ELECTRONIC DEVICE SUPPORTING NON-TERRESTRIAL NETWORK COMMUNICATION AND OPERATING METHOD THEREFOR

(71) Applicant: Samsung Electronics Co., Ltd., Suwon-si (KR)

(72) Inventors: Sangwon KIM, Suwon-si (KR); Dongho Kim, Suwon-si (KR)

(73) Assignee: Samsung Electronics Co., Ltd., Suwon-si (KR)

(21) Appl. No.: 19/398,359

(22) Filed: Nov. 24, 2025

Related U.S. Application Data
(63) Continuation of application No. PCT/KR2024/005701, filed on Apr. 26, 2024.

(30) Foreign Application Priority Data
May 25, 2023 (KR) 10-2023-0067569
Aug. 24, 2023 (KR) 10-2023-0111062

(51) Int. Cl. H04W 48/16; H04W 60/04; H04W 84/04

(52) U.S. Cl. CPC H04W 48/16; H04W 60/04; H04W 84/042

(57) ABSTRACT

An electronic device includes: at least one communication circuit; at least one processor operably connected to the at least one communication circuit; and memory storing instructions, wherein the instructions, when executed by the at least one processor individually or collectively, cause the electronic device to: perform a public land mobile network (PLMN) search operation via the at least one communication circuit, select a PLMN based on a result of the PLMN search operation, identify whether the selected PLMN is a PLMN of a non-terrestrial network (NTN), based on identifying that the selected PLMN is the PLMN of the NTN, identify whether a first condition is satisfied, and based on identifying that the first condition is satisfied, skip a registration operation for the selected PLMN.

### CROSS-REFERENCE TO RELATED APPLICATIONS

This application is a bypass continuation application of International Application No. PCT/KR2024/005701, filed on Apr. 26, 2024, which claims priority to Korean Patent Application No. 10-2023-0067569, filed on May 25, 2023, and Korean Patent Application No. 10-2023-0111062, filed on Aug. 24, 2023 in the Korean Intellectual Property Office, the disclosures of which are incorporated by reference herein in their entireties.

### BACKGROUND

### 1. Field

The disclosure relates to an electronic device for supporting a non-terrestrial network communication and an operating method thereof.

### 2. Description of Related Art

Recently, electronic devices supporting a non-terrestrial network communication (e.g., a satellite communication) have been actively introduced. For example, the electronic device may communicate with a satellite of a satellite communication company using a frequency and a communication scheme of the satellite communication company. For example, the electronic device may communicate with a satellite by using a cellular frequency according to a long-term evolution (LTE) standard (or, a 5^{th} generation (5G) standard) based on the LTE standard. For example, the electronic device may also communicate with a satellite based on a 5G non-terrestrial networks (NTN) technology.

For example, if the electronic device performs a communication with a non-terrestrial network based on the LTE standard, some of frequencies defined in the LTE standard may be used for a non-terrestrial network communication. The electronic device may perform a satellite communication using a protocol stack used in a terrestrial network communication, and an additional protocol stack for the non-terrestrial network communication may not be required. The electronic device may perform a communication without distinguishing between the non-terrestrial network communication and the terrestrial network communication. For example, the electronic device may perform a cell scan operation, perform a camp on operation for a cell which satisfies cell selection criteria, and perform an operation for accessing a network. For example, the operation for accessing the network may include a camp on operation, a random access (RA) operation, a connection establishment operation, and/or an attach operation (or a registration operation). The electronic device may perform an operation for camping on a cell which satisfies cell selection criteria and an operation for accessing a network without distinguishing between the non-terrestrial network communication and the terrestrial network communication. Accordingly, in substantially the same manner as the terrestrial network communication, the electronic device may prepare for performing the non-terrestrial network communication.

### SUMMARY

According to an aspect of the disclosure, an electronic device includes: at least one communication circuit; at least one processor operably connected to the at least one communication circuit; and memory storing instructions, wherein the instructions, when executed by the at least one processor individually or collectively, cause the electronic device to: perform a public land mobile network (PLMN) search operation via the at least one communication circuit, select a PLMN based on a result of the PLMN search operation, identify whether the selected PLMN is a PLMN of a non-terrestrial network (NTN), based on identifying that the selected PLMN is the PLMN of the NTN, identify whether a first condition is satisfied, and based on identifying that the first condition is satisfied, skip a registration operation for the selected PLMN.

The instructions, when executed by the at least one processor individually or collectively, may cause the electronic device to: based on identifying that the first condition is not satisfied, perform the registration operation for the selected PLMN via the at least one communication circuit.

The electronic device may further include a display, and the instructions, when executed by the at least one processor individually or collectively, may cause the electronic device to: after skipping the registration operation for the selected PLMN, identify whether a second condition is satisfied, and based on identifying that the second condition is satisfied, display information about the selected PLMN via the display.

The instructions, when executed by the at least one processor individually or collectively, may cause the electronic device to: before performing the PLMN search operation, identify a user input for selecting a menu for setting a mode in which the registration operation for at least one PLMN of the NTN is skipped, and set the mode based on the user input.

The instructions, when executed by the at least one processor individually or collectively, may cause the electronic device to: after skipping the registration operation for the selected PLMN, identify whether a second condition is satisfied, and based on identifying that the second condition is satisfied, perform the PLMN search operation.

The instructions, when executed by the at least one processor individually or collectively, may cause the electronic device to, before performing the PLMN search operation based on identifying that the second condition is satisfied, release the setting for the mode.

The electronic device may further include a display, wherein the instructions, when executed by the at least one processor individually or collectively, may cause the electronic device to: after selecting the PLMN, identify whether a mode in which the registration operation for at least one PLMN of the NTN is skipped is set, based on identifying that the mode is not set, perform the registration operation for the selected PLMN via the at least one communication circuit, after performing the registration operation for the selected PLMN, identify whether a third condition is satisfied, and based on identifying that the third condition is satisfied, output information for recommending selection of the mode via the display.

The first condition may include at least one of: a condition in which there is no data traffic transmission/reception by the at least one processor during a set time, a condition in which there is no user input during the set time, or a condition in which there is a connection based on a radio access technology (RAT) of a non-3rd generation partnership project (non-3GPP).

The second condition may include at least one of: a condition in which there is data traffic transmission/reception by the at least one processor, a condition in which there is a user input, or a condition in which there is no connection based on a radio access technology (RAT) of a non-3rd generation partnership project (non-3GPP).

The instructions, when executed by the at least one processor individually or collectively, may cause the electronic device to: based on identifying that the first condition is not satisfied, perform the registration operation for the selected PLMN via the at least one communication circuit.

According to an aspect of the disclosure, a method includes: performing a public land mobile network (PLMN) search operation; selecting a PLMN based on a result of the PLMN search operation; identifying whether the selected PLMN is a PLMN of a non-terrestrial network (NTN); based on identifying that the selected PLMN is the PLMN of the NTN, identifying whether a first condition is satisfied; and based on identifying that the first condition is satisfied, skipping a registration operation for the selected PLMN.

The method may further include, based on identifying that the first condition is not satisfied, performing the registration operation for the selected PLMN.

The method may further include: after skipping the registration operation for the PLMN selected, identifying whether a second condition is satisfied; and based on identifying that the second condition is satisfied, displaying information about the selected PLMN.

The method may further include: before performing the PLMN search operation, identifying a user input for selecting a menu for setting a mode in which the registration operation for at least one PLMN of the NTN is skipped; and setting the mode based on the user input.

According to an aspect of the disclosure, a non-transitory computer-readable recording medium stores at least one computer-readable instruction, the at least one instruction, when executed by at least one processor of an electronic device individually or collectively, causes the electronic device to: perform a public land mobile network (PLMN) search operation; select a PLMN based on a result of the PLMN search operation; identify whether the selected PLMN is a PLMN of a non-terrestrial network (NTN); based on identifying that the selected PLMN is the PLMN of the NTN, identifying whether a first condition is satisfied; and based on identifying that the first condition is satisfied, skipping a registration operation for the selected PLMN . . .

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device within a network environment according to an embodiment;

FIG. 2 is a diagram illustrating an electronic device and a long-range communication network environment according to an embodiment;

FIG. 3 is a diagram for describing an access of an electronic device according to an embodiment;

FIG. 4 is a diagram for describing a non-terrestrial network system according to an embodiment;

FIG. 5 is a drawing for describing degradation in a service coverage according to a comparative example for comparison with an embodiment;

FIG. 6 is a flowchart illustrating a method of operating an electronic device according to an embodiment;

FIG. 7A is a flowchart illustrating a method of operating an electronic device according to an embodiment;

FIG. 7B is a flowchart illustrating a method of operating an electronic device according to an embodiment;

FIG. 8 is a drawing for describing a menu for setting a smart NTN mode an electronic device according to an embodiment;

FIG. 9 is a flowchart illustrating a method of operating an electronic device according to an embodiment;

FIG. 10A is a flowchart illustrating a method of operating an electronic device according to an embodiment;

FIG. 10B is a flowchart illustrating a method of operating an electronic device according to an embodiment;

FIG. 11 is a signal flow for describing an operation of an electronic device according to an embodiment; and

FIG. 12 is a signal flow for describing an operation of an electronic device according to an embodiment.

### DETAILED DISCLOSURE

Hereinafter, example embodiments of the disclosure will be described in detail with reference to the accompanying drawings. In the following description of example embodiments of the disclosure, a detailed description of relevant known functions or configurations incorporated herein will be omitted when it is determined that the description may make the subject matter of an embodiment of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

It should be noted that the technical terms used herein are only used to describe a specific embodiment, and are not intended to limit an embodiment of the disclosure. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, when the technical terms used herein are wrong technical terms that cannot correctly represent the idea of the disclosure, it should be appreciated that they are replaced by technical terms correctly understood by those skilled in the art. Alternatively, the general terms used in an embodiment of the disclosure should be interpreted as defined in dictionaries or interpreted in the context of the relevant part, and should not be interpreted to have excessively restricted meanings.

Alternatively, a singular expression used herein may include a plural expression unless they are definitely different in the context. As used herein, such an expression as “comprises” or “include”, or the like should not be interpreted to necessarily include all elements or all operations described in the specification, and should be interpreted to be allowed to exclude some of them or further include additional elements or operations.

As used herein, the terms “1st” or “first” and “2nd” or “second” may use corresponding components regardless of importance or order and are used to distinguish one component from another without limiting the components

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Hereinafter, an embodiment of the disclosure will be described in detail with reference to the accompanying drawings. Regardless of drawing signs, the same or like elements are provided with the same reference numeral, and a repeated description thereof will be omitted. Alternatively, in describing an embodiment of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an electronic device will be described as an example in an embodiment of the disclosure, but the electronic device may be referred to as a terminal, a mobile station, a mobile equipment (ME), a user equipment (UE), a user terminal (UT), a subscriber station (SS), a wireless device, a handheld device, or an access terminal (AT). Alternatively, in an embodiment of the disclosure, the electronic device may be a device having a communication function such as, for example, a mobile phone, a personal digital assistant (PDA), a smart phone, a wireless MODEM, or a notebook.

Hereinafter, in an embodiment of the disclosure, a base station will be described as an example, but the base station may be referred to as at least one of a gNode B, a gNB, an eNode B, an eNB, a Node B, a BS, a radio access unit, a base station controller, or a node on a network. Further, the base station may be a network entity including at least one of an integrated access and backhaul-donor (IAB-donor) which is a gNB which provides a network access to electronic device(s) via a network of backhaul and access links in a new radio (NR) system, and an IAB-node which is a radio access network (RAN) node which supports NR access link(s) to the electronic device(s) and supports NR backhaul links to the IAB-donor or another IAB-node. In an embodiment of the disclosure, the electronic device may be wirelessly accessed via the IAB-node and may transmit and receive data with an IAB-donor connected to at least one IAB-node via a backhaul link.

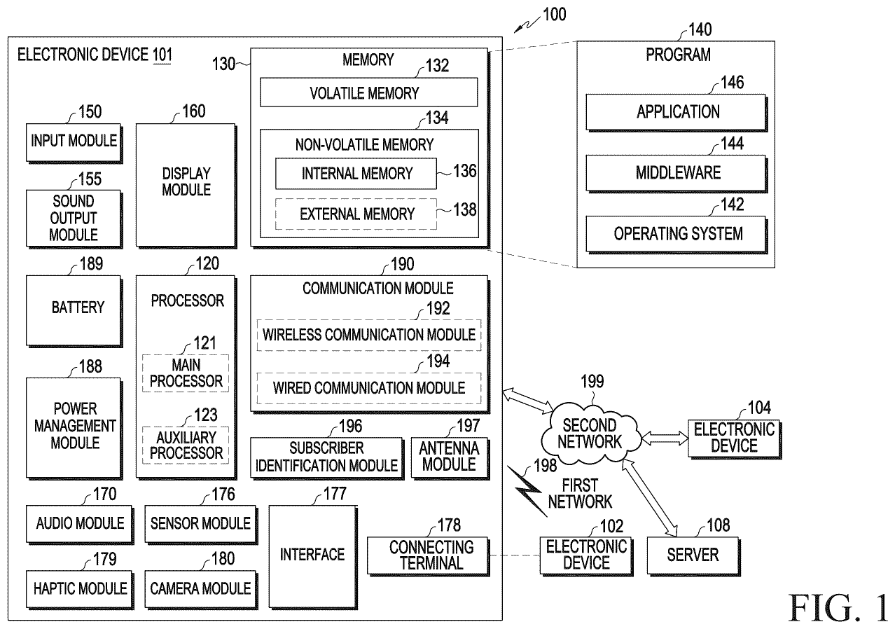

FIG. 1 is a block diagram schematically illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may acquire the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless fidelity (WiFi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to some embodiments, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to a particular embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

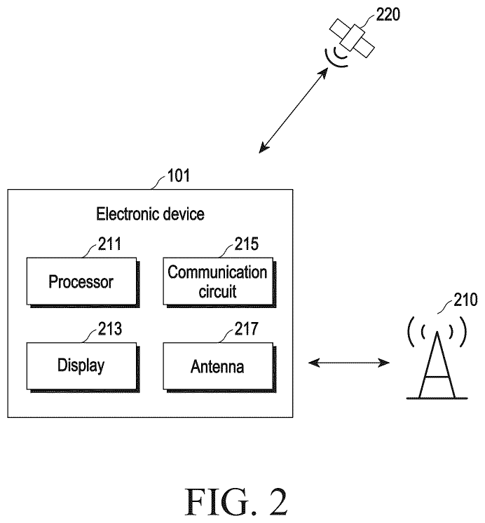

FIG. 2 is a diagram illustrating an electronic device and a long-range communication network environment according to an embodiment.

An electronic device 101 may transmit and/or receive data via a terrestrial network and/or a non-terrestrial network. The electronic device 101 may have the same as the configuration of the electronic device 101 illustrated in FIG. 1 or may include the configuration of the electronic device 101 illustrated in FIG. 1.

The terrestrial network may refer to a network capable of providing a data communication via a terrestrial wireless communication device 210. For example, the terrestrial wireless communication device 210 may include a base station located on the ground (e.g., fixed to the ground). The terrestrial wireless communication device 210 may support at least one of various communication schemes supportable by the electronic device 101. For example, the terrestrial wireless communication device 210 may include an eNodeB (e.g., an LTE-based base station) or a gNodeB (e.g., a 5G (or new radio (NR))-based base station), but is not limited thereto.

The non-terrestrial network may refer to a network capable of providing a data communication via at least one non-terrestrial wireless communication device 220. For example, the non-terrestrial wireless communication device 220 may include at least one of various communication devices such as a base station and a repeater which are not located on the ground. For example, the non-terrestrial wireless communication device 220 may include a satellite and/or an unmanned aerial vehicle, but is not limited thereto. For example, the satellite may include a low-earth orbit (LEO) satellite, a medium-earth orbit (MEO) satellite, a geostationary earth orbit (GEO) satellite, and/or a high elliptical orbit (HEO) satellite. For example, the satellite may include an orbiting satellite and/or a geostationary satellite.

The non-terrestrial wireless communication device 220 may support at least one of various wireless communication schemes. For example, the non-terrestrial wireless communication device 220 may support an NR non-terrestrial network (NTN) defined by 3rd generation partnership project (3GPP). Alternatively, the non-terrestrial wireless communication device 220 may support at least one of communication schemes based on various communication standards such as LTE, global system for mobile communications (GSM), or code-division multiple access (CDMA), but is not limited thereto.

The terrestrial network and the non-terrestrial network may be networks independent of each other. Alternatively, the terrestrial network and the non-terrestrial network may be included in at least one network (e.g., a network provided by the same provider) associated with each other.

If a communication with the terrestrial network is not possible or is not seamless, the electronic device 101 may perform a wireless communication via the non-terrestrial network. Alternatively, the electronic device 101 may perform a wireless communication via the non-terrestrial network regardless of a communication state with the terrestrial network.

According to an embodiment, the electronic device 101 may include a processor 211 (e.g., a processor 120 in FIG. 1), a display 213 (e.g., a display module 160 in FIG. 1), a communication circuit 215 (e.g., a communication module 190 in FIG. 1), and/or an antenna 217 (e.g., an antenna module 197 in FIG. 1). For example, the processor 211 may be operatively, functionally, and/or electrically connected to the display 213, the communication circuit 215, and/or the antenna 217.

The processor 211 may execute, e.g., instructions (e.g., a program 140 in FIG. 1) at least temporarily stored in memory (e.g., memory 130 in FIG. 1) to control at least one other component (e.g., a hardware or software component) of the electronic device 101 connected to the processor 211, and may perform various data processing or computation. According to an embodiment, the processor 211 may control the overall operation related to a terrestrial network communication and/or non-terrestrial network communication. For example, the processor 211 may include a communication processor (e.g., an auxiliary processor 123 in FIG. 1) related to the terrestrial network communication and/or non-terrestrial network communication.

The display 213 may visually provide information to the outside (e.g., a user) of the electronic device 101.

According to an embodiment, the display 213 may display a user interface (UI) indicating information related to the terrestrial network and/or a non-terrestrial network. For example, the UI indicating the information related to the terrestrial network and/or the non-terrestrial network may include at least one of UIs indicating information related to a type of a network (e.g., cellular communication (3G, 4G, or 5G), short-range communication (e.g., BT, or WI-FI), or satellite communication), a type of network service provider (e.g., satellite communication service provider (Iridium), emergency service provider (ESP)), strength of a network signal (e.g., signal strength bars, RSSI, or RSRP), a direction of a communication device (satellite) included in a network (e.g., an orientation, an elevation angle, or an azimuth angle), presence information, and/or a network communication state (e.g., idle, transmit, or receive).

According to an embodiment, the display 213 may display a UI indicating a service related to the terrestrial network and/or the non-terrestrial network.

According to an embodiment, the service related to the terrestrial network and/or the non-terrestrial network may include at least one of, e.g., an emergency message transmission service, a messaging service, a voice call, a video call, a data communication service, a location-related service, and/or a service related to an indicator.

According to an embodiment, the emergency message transmission service may include, but is not limited to, at least one of an SOS service state information providing service (e.g., display whether it is possible to provide an SOS service), a government office information providing service, an emergency contact information providing service, a text template providing service that minimizes text entry of the user, or a questionnaires service (e.g., a service for providing questionnaires, such as accident type, injured area, or medical information (e.g., age, gender, disease information, or medication information)) for quickly letting the emergency situation know.

According to an embodiment, the messaging service may include at least one of a short message service (SMS), a multimedia messaging service (MMS), or a rich communication suite (RCS) message, but is not limited thereto.

According to an embodiment, the data communication service may include a service via various applications (e.g., a web browser) that provide a data communication.

According to an embodiment, the location-related service may include, but is not limited to, at least one of longitude/latitude coordinates, location-related map information about the non-terrestrial wireless communication device 220, navigation, or a street view.

According to an embodiment, the UI example is not limited to the above-mentioned example, and may be provided via another output device (e.g., a sound output module 155 in FIG. 1).

According to an embodiment, the communication circuit 215 may support various types of wireless communication bands supported by the electronic device 101. For example, a wireless communication band supported by the electronic device 101 may include a short-range wireless communication band (e.g., BT or Wi-Fi), a terrestrial network (e.g., cellular network) communication band, and/or a non-terrestrial network band, but is not limited thereto.

According to an embodiment, the electronic device 101 may support a frequency band (e.g., n255, or n256) related to a non-terrestrial network wireless communication. The electronic device 101 may perform the non-terrestrial network wireless communication using a frequency band related to non-terrestrial network wireless communication, but is not limited thereto. For example, the electronic device 101 may perform the non-terrestrial network wireless communication using at least a portion of the frequency band related to a terrestrial network wireless communication.

According to an embodiment, the antenna 217 may transmit or receive a signal or power to or from the outside (e.g., an external electronic device).

According to an embodiment, the electronic device 101 may perform a wireless communication with the non-terrestrial network using at least one antenna among a plurality of antennas included in the antenna 217. At least one antenna supporting the non-terrestrial wireless communication may include a dedicated antenna and/or a multi-use antenna. The dedicated antenna may include an antenna supporting the non-terrestrial network. The multi-use antenna may include an antenna that supports different types of networks and non-terrestrial networks together. For example, the electronic device 101 may communicate with at least one satellite (e.g., a GNSS satellite or a satellite for emergency message service) using at least one non-terrestrial network-dedicated antenna. For example, the multi-use antenna may include an antenna supporting a short-range communication network (e.g., a Bluetooth network or a Wi-Fi network) and/or a terrestrial network (e.g., a long term evolution (LTE) network). The electronic device 101 may support a non-terrestrial network using a plurality of antennas among antennas supporting the terrestrial network.

Hereinafter, in the disclosure, a satellite is mainly mentioned as the non-terrestrial wireless communication device 220, and even if it is mentioned that the satellite provides a wireless communication based on a specific radio access technology (RAT) (e.g., LTE) or a specific function (e.g., a base station), this is merely an example, and the type thereof is not limited.

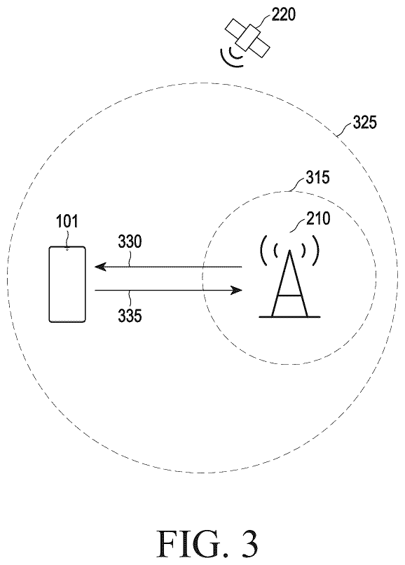

FIG. 3 is a diagram for describing an access of an electronic device according to an embodiment.

According to an embodiment, an electronic device 101 may be located within a terrestrial wireless communication coverage 315 of a terrestrial wireless communication device 210 and/or a non-terrestrial wireless communication coverage 325 of a non-terrestrial wireless communication device 220. The non-terrestrial wireless communication coverage 325 may be relatively larger (e.g., 50 times larger) than the terrestrial wireless communication coverage 315. For example, the non-terrestrial wireless communication coverage 325 may cover an area not covered by the coverage 315 of the terrestrial wireless communication device 210, and accordingly, the electronic device 101 may perform a communication even in an area where a terrestrial wireless communication is not supported.

According to an embodiment, the electronic device 101 may perform a cell scan within the terrestrial wireless communication coverage 315 and/or the non-terrestrial wireless communication coverage 325. As a result of performing the cell scan, the electronic device 101 may identify a cell provided by the terrestrial wireless communication device 210 and/or a cell provided by the non-terrestrial wireless communication device 220. If there is a cell that meets cell selection criteria, the electronic device 101 may perform at least some of operations for connecting to a network (e.g., a non-terrestrial network and/or a terrestrial network). Here, the connection to the network may include, e.g., at least some of a preceding operation (e.g., camping-on, or connection procedure (e.g., random access (RA) procedure)) for registration to the network and/or a registration operation (e.g., attach, or registration)) to the network, but is not limited thereto. If disconnection from the network is required (e.g., movement to another network), the electronic device 101 may perform at least some of disconnecting operations. The operations for disconnecting from the network may include at least some of a detach from the network, release of connection, and/or radio link failure (RLF) declaration, and is not limited to the listed operations.

According to an embodiment, the electronic device 101 may perform at least some of cell scan, disconnection from the network, and/or connection to the network according to movement 330 or 335.

According to an embodiment, if the electronic device 101 is located within the terrestrial wireless communication coverage 315 included in the non-terrestrial wireless communication coverage 325 or is located at a boundary area of the terrestrial wireless communication coverage 315, the electronic device 101 may connect to the terrestrial network and/or the non-terrestrial network based on a policy (e.g., a priority policy) of the electronic device 101.

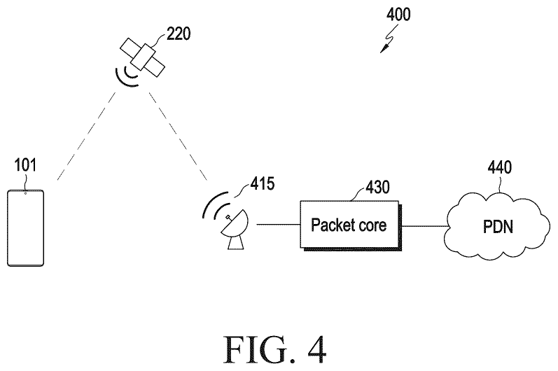

FIG. 4 is a diagram for describing a non-terrestrial network system 400 according to an embodiment.

Referring to FIG. 4, a non-terrestrial network system 400 may include a non-terrestrial wireless communication device 220, a radio unit 415, a packet core 430, and/or a PDN 440.

According to an embodiment, the non-terrestrial network system 400 may be implemented, e.g., in a regenerative scheme. When implemented in a regenerative scheme, the at least one non-terrestrial wireless communication device 220 may include a base station (e.g., eNode B). The non-terrestrial network system 400 may be implemented, e.g., in a bent-pipe scheme. The bent-pipe scheme may include a passive relay scheme that performs frequency conversion and power amplification on a received signal. If the non-terrestrial network system 400 is implemented in a bent-pipe scheme, the at least one non-terrestrial wireless communication device 220 may include a relay that converts (for example, amplifies) and transmits a signal. An implementation scheme of the non-terrestrial network system 400 and a role of the non-terrestrial wireless communication device 220 described in FIG. 4 are merely examples, and are not limited thereto.

According to an embodiment, the non-terrestrial wireless communication device 220 may include at least one satellite. The non-terrestrial wireless communication device 220 may communicate with, e.g., the electronic device 101 using a terrestrial network (e.g., a cellular network) band and/or a non-terrestrial network band. The terrestrial network band may be, e.g., an operating band supported by long term evolution (LTE) and/or new radio (NR), but is not limited thereto. The non-terrestrial network band may include a band (e.g., n255 and/or n256 bands) defined by 3GPP, but is not limited thereto.

According to an embodiment, the at least one radio unit 415 may receive a signal of the non-terrestrial wireless communication device 220 and transmit the signal to the packet core 430. The radio unit 415 and the non-terrestrial wireless communication device 220 may perform a communication using, e.g., the non-terrestrial network band. The non-terrestrial network band may be different from the terrestrial network band, but may be set to be the same in some cases.

According to an embodiment, the at least one packet core 430 may transmit and receive data associated with the electronic device 101 using the radio unit 415. Accordingly, the packet core 430 may process the data associated with the electronic device 101 and transmit the processed data to a packet data network (PDN) 440 (e.g., the Internet). The packet core 430 may include, e.g., at least some of an evolved packet core (EPC) and/or a 5G core (5GC), but is not limited thereto. The packet core 430 may include a packet core associated with an operator of the non-terrestrial wireless communication device 220 and/or a packet core associated with a mobile network operator (MNO). The packet core 430 may be additionally connected to a public switched telephone network (PSTN) (not shown) to transmit and receive data associated with the electronic device 101.

Among satellites which provide a service based on a 3GPP standard, a low-earth bit (LEO) satellite has a feature of orbiting around a set orbit at a relatively high speed. For example, service coverage time of the LEO satellite may be expected to be about 8 minutes.

A non-terrestrial network (e.g., a satellite network) may have a mobility, unlike a terrestrial network. Therefore, the non-terrestrial network may have a characteristic that a serving cell of an electronic device may change due to the mobility of the non-terrestrial network, even if the electronic device does not move.

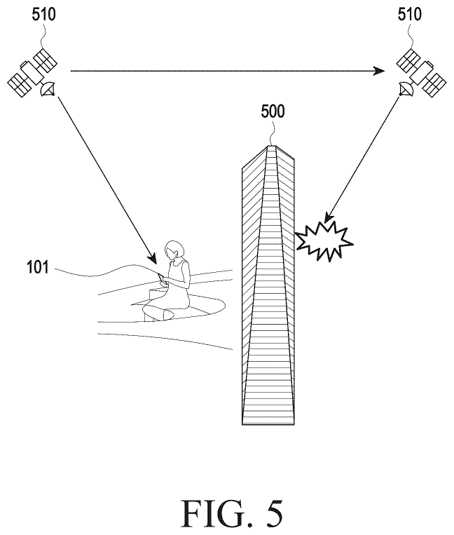

As such, to overcome relatively short coverage time due to a mobility of a satellite network, satellite providers are trying to provide a stable service by operating a relatively large number of satellites such as tens to thousands in low orbit. However, even if it is possible to provide a continuous service using the relatively large number of satellites, degradation in a service coverage may occur according to a location and a direction of the electronic device, and a service interruption (service lost) phenomenon may occur due to the degradation in the service coverage. This will be described with reference to FIG. 5 as follows.

FIG. 5 is a drawing for describing degradation in a service coverage according to a comparative example for comparison with an embodiment.

Referring to FIG. 5, if there is an obstacle 500 such as a relatively large building in a specific direction with respect to an electronic device 101 (an electronic device 101 in FIG. 1, FIG. 2, FIG. 3, or FIG. 4), when a location on orbit of a satellite 510 (e.g., a non-terrestrial wireless communication device 220 in FIG. 2, FIG. 3, or FIG. 4) becomes behind the obstacle 500, a service interruption (service lost) phenomenon may occur due to the obstacle 500. In this case, a service availability range of a service provided via the satellite 510 may be reduced by half, and in this case, a ping-pong phenomenon may occur in which a registration operation for a satellite network and an operation of providing a limited service are performed alternately and frequently, and this ping-pong phenomenon may increase current consumption of the electronic device 101. In a case of a satellite service which requires relatively large transmission power, a registration operation for the satellite service alone may cause excessive current consumption of the electronic device 101, and this may result in a decrease in usability of the electronic device 101.

The electronic device 101 may exist in an idle state, and a case may occur in the idle state that a registration operation for a satellite network, and/or a deregistration operation for the satellite network due to various situations such as a radio link failure (RLF), and/or a service interruption are repeatedly performed. In this case, current of the electronic device 101 may be excessively consumed, and this may result in degradation in usability of the electronic device 101. The idle state may include at least one of a sleep state of an application processor of the electronic device 101, a state in which the electronic device 101 is not used by a user during set time, and/or a state in which there is no data traffic transmission/reception by a communication processor during the set time. If the electronic device 101 exists in the idle state, a screen (e.g., a display module 160 in FIG. 1 or a display 213 in FIG. 2) of the electronic device 101 may be turned off.

An embodiment of the disclosure may provide an electronic device supporting a non-terrestrial network communication and an operating method thereof.

According to an embodiment of the disclosure, an electronic device (101) may comprise at least one communication circuit (190; 215), at least one processor (120; 211) operably connected to the at least one communication circuit; and memory (130) storing instructions.

According to an embodiment of the disclosure, the instructions, when executed by the at least one processor, may cause the electronic device to perform a public land mobile network (PLMN) search operation via the at least one communication circuit.

According to an embodiment of the disclosure, the instructions, when executed by the at least one processor, may cause the electronic device to select a PLMN based on a result of the PLMN search operation.

According to an embodiment of the disclosure, the instructions, when executed by the at least one processor, may cause the electronic device to identify whether the selected PLMN is a PLMN of a non-terrestrial network (NTN).

According to an embodiment of the disclosure, the instructions, when executed by the at least one processor, may cause the electronic device to, based on identifying that the selected PLMN is the PLMN of the NTN, identify whether a first condition is satisfied.

According to an embodiment of the disclosure, the instructions, when executed by the at least one processor, may cause the electronic device to, based on identifying that the first condition is satisfied, skip a registration operation for the selected PLMN via the at least one communication circuit.

According to an embodiment of the disclosure, the instructions, when executed by the at least one processor, may cause the electronic device to, based on identifying that the first condition is not satisfied, perform the registration operation for the selected PLMN.

According to an embodiment of the disclosure, the electronic device may further comprise a display (213).

According to an embodiment of the disclosure, the instructions, when executed by the at least one processor, may cause the electronic device to, after skipping the registration operation for the selected PLMN, identify whether a second condition is satisfied.

According to an embodiment of the disclosure, the instructions, when executed by the at least one processor, may cause the electronic device to, based on identifying that the second condition is satisfied, display information about the selected PLMN via the display.

According to an embodiment of the disclosure, the instructions, when executed by the at least one processor, may cause the electronic device to, before performing the PLMN search operation, identify a user input for selecting a menu for setting a mode in which a registration operation for at least one PLMN of the NTN is skipped.

According to an embodiment of the disclosure, the instructions, when executed by the at least one processor, may cause the electronic device to set the mode based on the user input.

According to an embodiment of the disclosure, the instructions, when executed by the at least one processor, may cause the electronic device to, after skipping the registration operation for the selected PLMN, identify whether a second condition is satisfied.

According to an embodiment of the disclosure, the instructions, when executed by the at least one processor, may cause the electronic device to, based on identifying that the second condition is satisfied, return to the operation of performing the PLMN search operation.

According to an embodiment of the disclosure, the instructions, when executed by the at least one processor, may cause the electronic device to, before returning to the operation of performing the PLMN search operation based on identifying that the second condition is satisfied, release the setting for the mode.

According to an embodiment of the disclosure, the electronic device may comprise a display (213).

According to an embodiment of the disclosure, the instructions, when executed by the at least one processor, may cause the electronic device to, after selecting the PLMN, identify whether a mode in which a registration operation for at least one PLMN of the NTN is skipped is set.

According to an embodiment of the disclosure, the instructions, when executed by the at least one processor, may cause the electronic device to, based on identifying that the mode is not set, perform the registration operation for the selected PLMN via the at least one communication circuit.

According to an embodiment of the disclosure, the instructions, when executed by the at least one processor, may cause the electronic device to, after performing the registration operation for the selected PLMN, identify whether a third condition is satisfied.

According to an embodiment of the disclosure, the instructions, when executed by the at least one processor, may cause the electronic device to, based on identifying that the third condition is satisfied, output information for recommending selection of the mode via the display.

According to an embodiment of the disclosure, the first condition may include at least one of, a condition in which there is no data traffic transmission/reception by the at least one processor during set time, a condition in which there is no user input during the set time, or a condition in which there is a connection based on a radio access technology (RAT) of a non-3rd generation partnership project (non-3GPP).

According to an embodiment of the disclosure, the second condition includes at least one of a condition in which there is data traffic transmission/reception by the at least one processor, a condition in which there is a user input, or a condition in which there is no connection based on a radio access technology (RAT) of a non-3rd generation partnership project (non-3GPP).

According to an embodiment of the disclosure, the instructions, when executed by the at least one processor, may cause the electronic device to, based on identifying that the first condition is not satisfied, perform the registration operation for the selected PLMN via the at least one communication circuit.

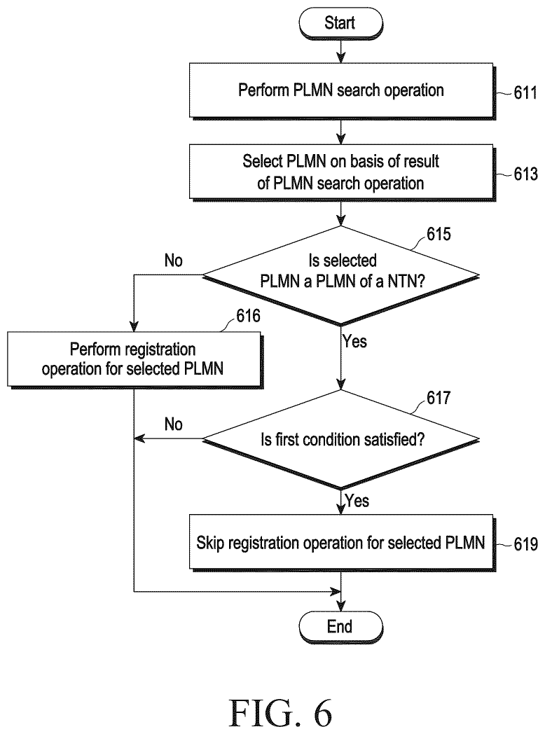

FIG. 6 is a flowchart illustrating a method of operating an electronic device according to an embodiment

Referring to FIG. 6, an electronic device (e.g., an electronic device 101 in FIG. 1, FIG. 2, FIG. 3, FIG. 4, or FIG. 5) (e.g., a processor 120 in FIG. 1 or a processor 211 in FIG. 2) may, in operation 611, perform a public land mobile network (PLMN) search operation via at least one communication circuit (e.g., a communication module 190 in FIG. 1 or a communication circuit 215 in FIG. 2). In an embodiment, the PLMN search operation may include a scan operation to discover available PLMNs. In an embodiment, the PLMN search operation may include a cell search operation. In an embodiment, the electronic device may perform the PLMN search operation when the electronic device is not registered with a PLMN.

The electronic device which performs the PLMN search operation may select a PLMN based on a result of the PLMN search operation in operation 613. By performing the PLMN search operation, the electronic device may find at least one PLMN and select a PLMN for which a registration operation will be performed among the at least one found PLMN.

The electronic device which selects the PLMN may, in operation 615, identify whether the selected PLMN is a PLMN of a non-terrestrial network (NTN). In an embodiment, the NTN may include a satellite network. In an embodiment, the electronic device may identify whether the selected PLMN is the PLMN of the NTN based on a PLMN list stored in memory (e.g., memory 130 in FIG. 1). In an embodiment, the PLMN list may include information (e.g., a PLMN identifier (ID)) related to PLMNs of the NTN. In an embodiment, the PLMN list may be updated if a new PLMN is generated in the NTN or a PLMN is removed from the NTN. In an embodiment, the PLMN list may be stored in the memory during the manufacturing of the electronic device, or may be stored in the memory after being received via a system information message (e.g., a system information block type 1 (SIB1) message), or may be obtained from information (e.g., a profile) stored in a SIM and stored in the memory, or may be received from a network (e.g., a base station) and stored in the memory. The PLMN list will be described below, so a detailed description thereof will be omitted herein.

As an identification result in operation 615, if the selected PLMN is not the PLMN of the NTN (Operation 615—No), the electronic device may perform a registration operation for the selected PLMN via the at least one communication circuit in operation 616.

As the identification result in operation 615, if the selected PLMN is the PLMN of the NTN (Operation 615—Yes), the electronic device may identify whether a first condition is satisfied in operation 617. In an embodiment, the first condition may include at least one of a condition in which there is no data traffic transmission/reception during a set time, a condition in which there is no user input during set time, or a condition in which there is a connection based on a radio access technology (RAT) of non-3rd generation partnership project (non-3GPP). In an embodiment, if the condition in which there is no user input during the set time is satisfied, a display (e.g., a display 213 in FIG. 2) of the electronic device may be turned off (for example, a screen-off may occur). In an embodiment, the RAT of non-3GPP may indicate a radio connection technology other than an RAT of 3GPP. For example, the RAT of non-3GPP may include a short-range wireless communication technology such as a Wi-Fi technology, a Bluetooth technology, or a ultra wideband (UWB) technology, and the RAT of 3GPP may include a cellular communication technology such as LTE, LTE-A, or NR.

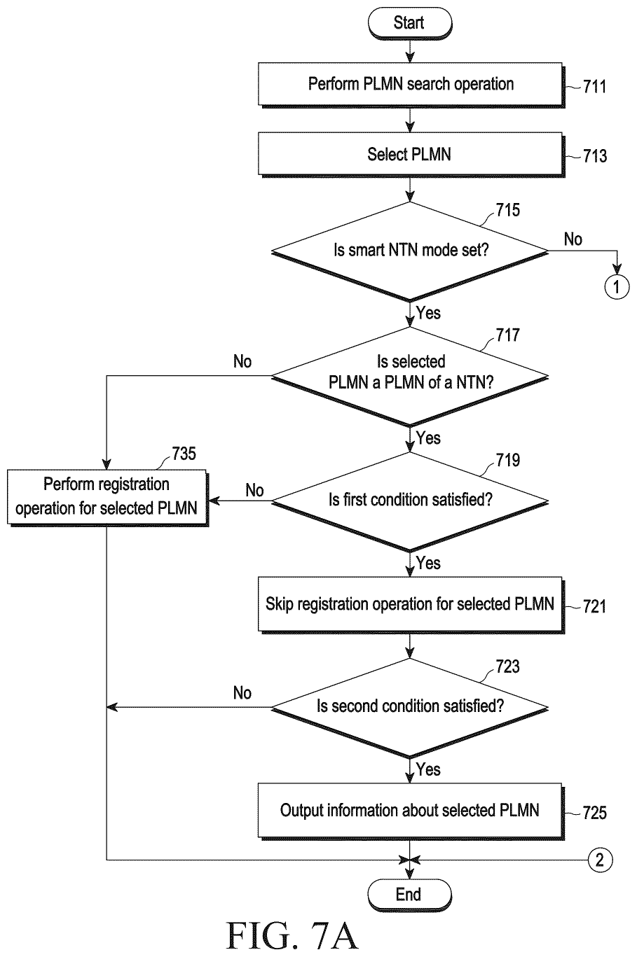

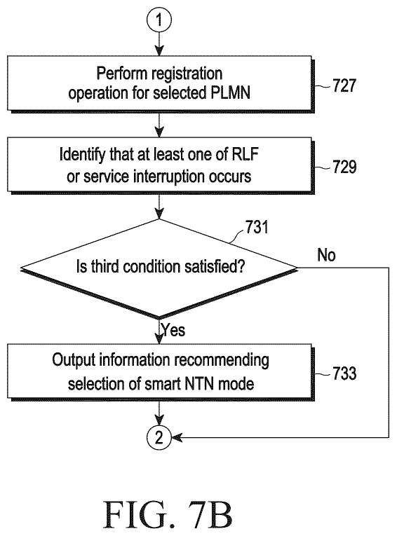

If the first condition is satisfied (Operation 617—Yes), the electronic device may skip the registration operation for the selected PLMN in operation 619. In an embodiment, skipping the registration operation for the selected PLMN may mean not performing the registration operation for the selected PLMN (for example, ignoring the registration operation for the selected PLMN). In an embodiment, the registration operation for the selected PLMN may include transmitting a registration request message to the selected PLMN and receiving a registration response message from the selected PLMN in response to the registration request message. Skipping the registration operation for the selected PLMN may mean ignoring (for example, not performing) the registration operation for the selected PLMN. As such, upon ignoring the registration operation for the selected PLMN, the electronic device may ignore an operation of transmitting the registration request message to the selected PLMN. If the first condition is not satisfied (Operation 617—No), the electronic device may terminate without performing any further operations. FIGS. 7A and 7B are flowcharts illustrating a method of operating an electronic device according to an embodiment.

Referring to FIGS. 7A and 7B, an electronic device (e.g., an electronic device 101 in FIG. 1, FIG. 2, FIG. 3, FIG. 4, or FIG. 5) (e.g., a processor 120 in FIG. 1 or a processor 211 in FIG. 2) may, in operation 711, perform a PLMN search operation via at least one communication circuit (e.g., a communication module 190 in FIG. 1 or a communication circuit 215 in FIG. 2). In an embodiment, the electronic device may perform the PLMN search operation when the electronic device is not registered with a PLMN.

The electronic device which performs the PLMN search operation may select a PLMN based on a result of the PLMN search operation in operation 713. By performing the PLMN search operation, the electronic device may find at least one PLMN and select a PLMN for which a registration operation will be performed among the at least one found PLMN. For example, the electronic device may select the PLMN for which the registration operation will be performed among the at least one found PLMN based on a PLMN selection operation specified in V18.3.2 of TS 23.122 of 3GPP.

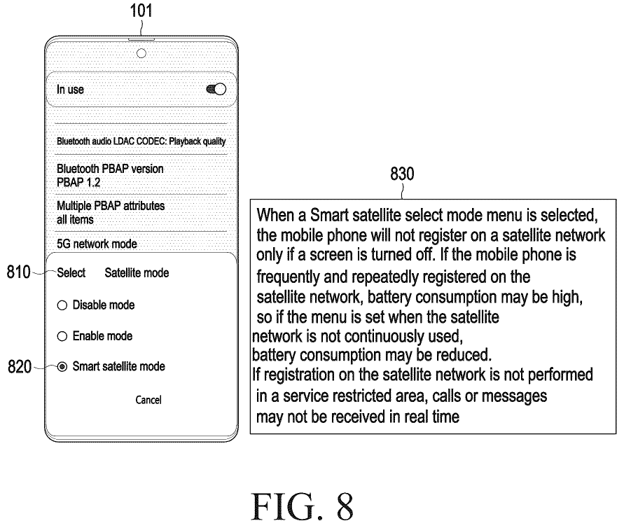

The electronic device which selects the PLMN may, in operation 715, identify whether a smart NTN mode is set. In an embodiment, the smart NTN mode may be a mode set to skip a registration operation for at least one PLMN of the NTN. In an embodiment, the smart NTN mode may be a mode set to limitedly activate the NTN. According to an embodiment, if the smart NTN mode is set, a registration operation for the PLMN of the NTN selected by the electronic device may be skipped if a first condition is satisfied. In an embodiment, the first condition may include at least one of a condition in which there is no data traffic transmission/reception during set time, a condition in which there is no user input during set time, or a condition in which there is a connection based on an RAT of non-3GPP. The first condition may be implemented to be similar or substantially the same as that described in FIG. 6, so a detailed description thereof will be omitted herein. Upon identifying a user input corresponding to a menu related to the smart NTN mode, the electronic device may output a guidance message indicating information about an advantage and/or disadvantage of setting the smart NTN mode via a display (e.g., display 213 in FIG. 2). The menu for setting the smart NTN mode will be described in detail below with reference to FIG. 8, so a detailed description thereof will be omitted herein.

As an identification result in operation 715, if the smart NTN mode is set (operation 715—Yes), the electronic device can check whether the selected PLMN is a PLMN of the NTN in operation 717. In an embodiment, the NTN may include a satellite network. In an embodiment, the electronic device may identify whether the selected PLMN is the PLMN of the NTN based on a PLMN list stored in memory (e.g., memory 130 in FIG. 1). In an embodiment, the PLMN list may include information (e.g., a PLMN identifier (ID)) related to PLMNs of the NTN. In an embodiment, the PLMN list may be updated if a new PLMN is generated in the NTN or a PLMN is removed from the NTN. In an embodiment, the PLMN list may be stored in the memory during the manufacturing of the electronic device, or may be stored in the memory after being received via a system information message (e.g., an SIB1 message), or may be obtained from information (e.g., a profile) stored in a SIM and stored in the memory, or may be received from a network (e.g., a base station) and stored in the memory.

In an embodiment, the PLMN list may be implemented as shown in Table 1 below.

TABLE 1

| Index | MCC | MNC | TAI | ACT |
|---|---|---|---|---|
| 1 | 901 | 01 | 1 | SAT |
| 2 | 901 | 02 | 3 | LTE |
| 3 | 901 | 02 | 4 | LTE |
| 4 | 901 | 03 | 1 | NR |

In Table 1, MCC may represent a mobile country code, MNC may represent a mobile network code, TAI may represent a tracking area identifier, and ACT may represent an access technology. In Table 1, SAT may represent a satellite.

As an identification result in operation 717, if the selected PLMN is the PLMN of the NTN (Operation 717—Yes), the electronic device may identify whether a first condition is satisfied in operation 719. In an embodiment, the first condition may include at least one of a condition in which there is no data traffic transmission/reception during set time, a condition in which there is no user input during set time, or a condition in which there is a connection based on a wireless RAT of non-3GPP. The first condition may be implemented to be similar or substantially the same as that described in FIG. 6, so a detailed description thereof will be omitted herein.

As an identification result in operation 719, if the first condition is satisfied (Operation 719—Yes), the electronic device may, in operation 721, skip the registration operation for the selected PLMN and provide only a limited service until the next PLMN search operation. In an embodiment, the limited service may include services such as an emergency call, an emergency message, an earthquake and tsunami warning system (ETWS) message, or a commercial mobile alert system (CMAS) message. In an embodiment, skipping (for example, ignoring) the registration operation for the selected PLMN may mean not performing the registration operation for the selected PLMN. In an embodiment, the registration operation for the selected PLMN may include transmitting a registration request message to the selected PLMN and receiving a registration response message from the selected PLMN in response to the registration request message.

The electronic device which skips the registration operation for the selected PLMN may identify whether a second condition is satisfied in operation 723. In an embodiment, the second condition may include at least one of a condition in which there is data traffic transmission/reception, a condition in which there is a user input, or a condition in which there is no connection based on the RAT of non-3GPP. As described in operation 719, when the first condition is satisfied, the electronic device may identify whether the second condition is satisfied again in operation 723. For example, the second condition may be a condition for identifying at least one of whether there is data traffic transmission/reception again in a state that there is no data traffic transmission/reception during the set time, whether there is a user input again in a state that there is no user input during the set time, or whether the connection based on the wireless RAT of non-3GPP is released. In an embodiment, operation 723 may be performed during set time, and the set time used in operation 723 may be identical to or different from the set time for the first condition.

As an identification result in operation 723, if the second condition is not satisfied (Operation 723—No), the electronic device may terminate without performing any further operations.

As the identification result in operation 723, if the second condition is satisfied (Operation 723—Yes), the electronic device may output information about the selected PLMN via the display in operation 725. In an embodiment, the information about the selected PLMN may be outputted in a form of pop-up, as a guidance message indicating that there is a PLMN which is selected but for which a registration operation is not performed. In an embodiment, there may be no limitation on a form of outputting the information about the selected PLMN. In an embodiment, there may be no limitation on information included in the information about the selected PLMN.

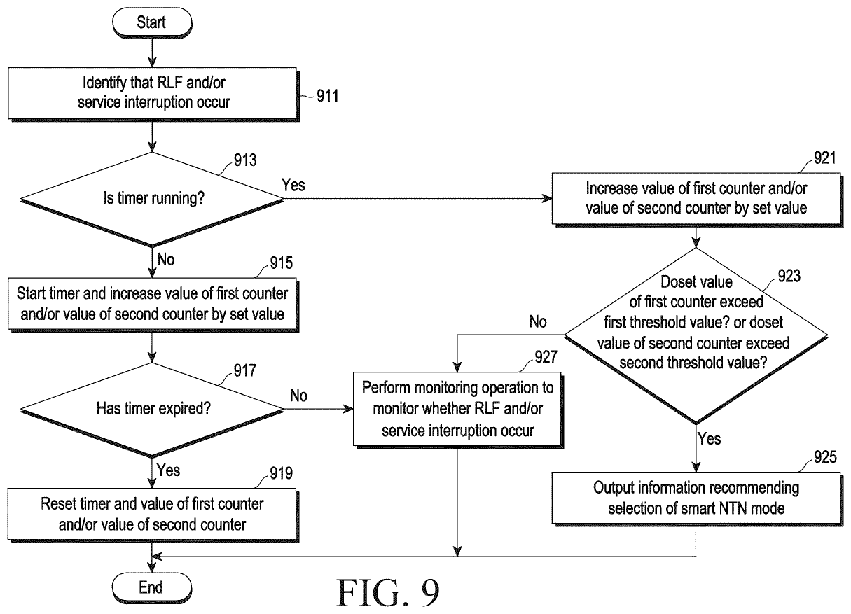

As the identification result in operation 715, if the smart NTN mode is not set (Operation 715—No), the electronic device may perform the registration operation for the selected PLMN in operation 727. The electronic device which performs the registration operation for the selected PLMN may identify that at least one of an RLF or a service interruption occurs in operation 729. The electronic device which identifies that the at least one of the RLF or the service interruption occurs may identify whether a third condition is satisfied in operation 731. The third condition may include at least one of a condition in which an RLF occurs a first set number of times or more during set time, or a condition in which a service interruption occurs a second set number of times or more during set time. In an embodiment, the set time may be time corresponding to a timer (e.g., a T_check_service_qual timer). In an embodiment, the first set number of times may be a number corresponding to an N_RLF counter. In an embodiment, the second set number of times may be a number corresponding to an N_Service lost counter. The set time used in the third condition may be identical to or different from the set time used in the first condition. The operation for identifying whether the third condition is satisfied will be described below with reference to FIG. 9, so a detailed description thereof will be omitted herein.

As an identification result in operation 731, if the third condition is not satisfied (Operation 731—No), the electronic device may terminate without performing any further operations.

As the identification result in operation 731, if the third condition is satisfied (Operation 731—Yes), the electronic device may output information guiding selection of the smart NTN mode via the display in operation 733. In an embodiment, information recommending the selection of the smart NTN mode may be outputted in a pop-up form, and there may be no limitation on a form of outputting the information recommending the selection of the smart NTN mode.

As the identification result in operation 717, if the selected PLMN is not the PLMN of the NTN (Operation 717—No), the electronic device may perform the registration operation for the selected PLMN in operation 735.

As the identification result in operation 719, if the first condition is not satisfied (Operation 719—No), the electronic device may perform the registration operation for the selected PLMN in operation 735.

FIG. 8 is a diagram illustrating a menu for setting a smart NTN mode in an electronic device, according to an embodiment.

Referring to FIG. 8, a smart NTN mode may be a mode configured to skip a registration operation for at least one PLMN of an NTN. In an embodiment, the smart NTN mode may be a mode configured to limitedly activate the NTN.

In an embodiment, the menu for setting the smart NTN mode may be a sub-menu of an NTN-related menu related to use of the NTN (e.g., a satellite network). The NTN-related menu (e.g., a satellite mode selection menu) may include at least one of a first menu which is a menu for setting an activation mode for activating the NTN, a second menu which is a menu for setting a deactivation mode for deactivating the NTN, or a third menu which is a menu for setting the smart NTN mode (e.g., a smart satellite selection menu).

An electronic device 101 (e.g., an electronic device 101 in FIG. 1, FIG. 2, FIG. 3, FIG. 4, or FIG. 5) (e.g., a processor 120 in FIG. 1 or a processor 211 in FIG. 2) may output an NTN-related menu 810 related to use of the NTN (e.g., the satellite network) via a display (e.g., a display 213 in FIG. 2). The NTN-related menu (e.g., the satellite mode selection menu) 810 may include at least one of the first menu for setting the activation mode, the second menu for setting the deactivation mode, or the third menu 820 for setting the smart NTN mode. In FIG. 8, the NTN-related menu 810 related to the use of the NTN may be displayed as “Select Satellite mode”, the first menu may be displayed as “Disable mode”, the second menu may be displayed as “Enable mode”, and the third menu 820 may be displayed as “Smart satellite select mode”.

In an embodiment, if the third menu is selected, the smart NTN mode may be set, and in the smart NTN mode, a registration operation for a PLMN of the NTN selected by the electronic device may be skipped if a first condition is satisfied. In an embodiment, the first condition may include at least one of a condition in which there is no data traffic transmission/reception during set time, a condition in which there is no user input during set time, or a condition in which there is a connection based on an RAT of non-3GPP. The first condition may be implemented to be similar to or substantially the same as that described in FIG. 6, so a detailed description thereof will be omitted herein. Upon identifying a user input corresponding to the third menu 820 for setting the smart NTN mode, the electronic device 101 may output a guidance message 830 indicating information about an advantage and/or disadvantage of setting the smart NTN mode via the display. In FIG. 8, the guidance message 830 indicating the information about the advantage and/or disadvantage of setting the third menu 820 for setting the smart NTN mode may be displayed as “When a Smart satellite select mode menu is selected, the mobile phone will not register on a satellite network only if a screen is turned off. If the mobile phone is frequently and repeatedly registered on the satellite network, battery consumption may be high, so if the menu is set when the satellite network is not continuously used, battery consumption may be reduced. If registration on the satellite network is not performed in a service restricted area, calls or messages may not be received in real time”.

In FIG. 8, a name or content of each menu and message may be changed in various forms as needed, and there may be no limitation on the name or content of each menu and message.

FIG. 9 is a flowchart illustrating a method of operating an electronic device according to an embodiment.

Before describing FIG. 9, an operation of the electronic device illustrated in FIG. 9 may be an operation for identifying whether a third condition is satisfied. The third condition may include at least one of a condition in which an RLF occurs a first set number of times or more during set time, or a condition in which a service interruption occurs a second set number of times or more during set time. In an embodiment, the set time may be time corresponding to a timer (e.g., a T_check_service_qual timer). In an embodiment, the first set number of times may be a number corresponding to a first counter (e.g., an N_RLF counter). In an embodiment, the second set number of times may be a number corresponding to a second counter (e.g., an N_Service lost counter). The set time used in the third condition may be identical to or different from the set time used in the first condition.

Referring to FIG. 9, the electronic device (e.g., an electronic device 101 in FIG. 1, FIG. 2, FIG. 3, FIG. 4, or FIG. 5) (e.g., a processor 120 in FIG. 1 or a processor 211 in FIG. 2) may identify that an RLF and/or service interruption occur in operation 911.

The electronic device which identifies that the RLF and/or service interruption occur may identify whether a timer (e.g., a T_check_service_qual timer) is running in operation 913. In an embodiment, the T_check_service_qual timer may wait set time to count the number of occurrences of the RLF and/or the number of occurrences of the service interruption related to the third condition.

As an identification result in operation 913, if the timer is not running (Operation 913—No), the electronic device may, in operation 915, start a timer and increase a value of the first counter (e.g., the N_RLF counter) which is the counter for counting the number of occurrences of the RLF and/or a value of the second counter (e.g., the N_Service lost counter) which is the counter for counting the number of occurrences of the service interruption by a set value (e.g., 1). In an embodiment, an initial value of each of the N_RLF counter and the N_Service lost counter may be a set value (e.g., 0).

The electronic device which starts the timer and increases the value of the first counter and/or the value of the second counter by the set value may identify whether the timer has expired in operation 917.

As an identification result in operation 917, if the timer has expired (Operation 917—Yes), the electronic device may reset the timer and the values of the first counter and/or the second counter in operation 919.

As the identification result in operation 913, if the timer is running (Operation 913—Yes), the electronic device may increase the value of the first counter and/or the value of the second counter by the set value (e.g., 1) in operation 921.

The electronic device which increases the value of the first counter and/or the value of the second counter by the set value may identify whether the value of the first counter exceeds a first threshold value (e.g., Threx_rlf) or whether the value of the second counter exceeds a second threshold value (e.g., Thre_sv_lost) in operation 923.

As an identification result in operation 923, if the value of the first counter exceeds the first threshold value or the value of the second counter exceeds the second threshold value (Operation 923—Yes), the electronic device may output information recommending selection of the smart NTN mode via a display (e.g., a display 213 in FIG. 2) in operation 925. In an embodiment, if the value of the first counter exceeds the first threshold value and/or the value of the second counter exceeds the second threshold value, the electronic device may identify that the third condition is satisfied. In an embodiment, information guiding selection of the smart NTN mode may be outputted in a form of a pop-up, and there may be no limitation on a form of outputting the information recommending the selection of the smart NTN mode.

As the identification result in operation 923, if the value of the first counter does not exceed the first threshold or the value of the second counter does not exceed the second threshold (Operation 923—No), the electronic device may perform a monitoring operation to monitor whether an RLF and/or service interruption occur in operation 927.

As the identification result in operation 917, if the timer has not expired (Operation 917—No), the electronic device may perform the monitoring operation to monitor whether the RLF and/or service interruption occur in operation 927. For example, if the RLF and/or service interruption occur in operation 927, operation 911 may be performed.

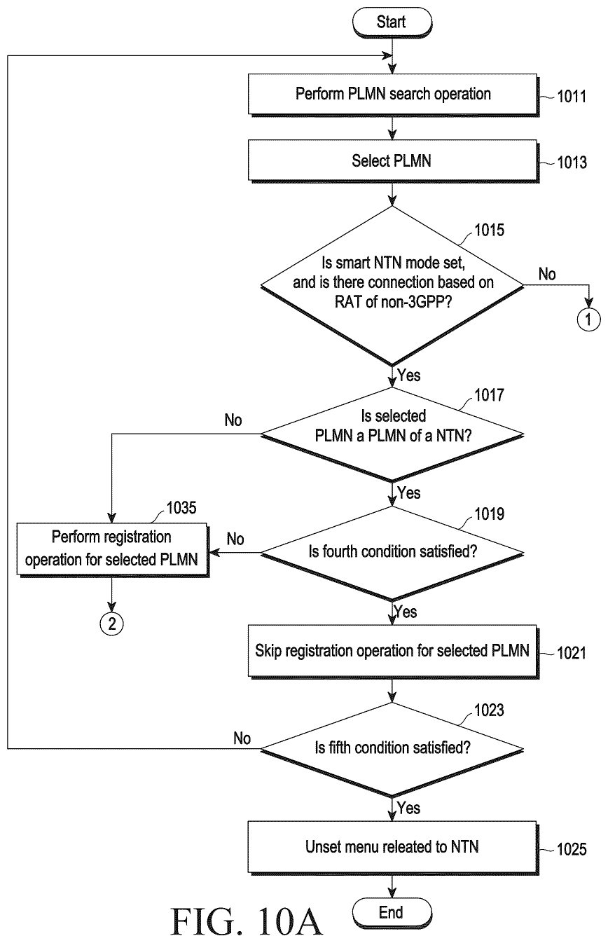

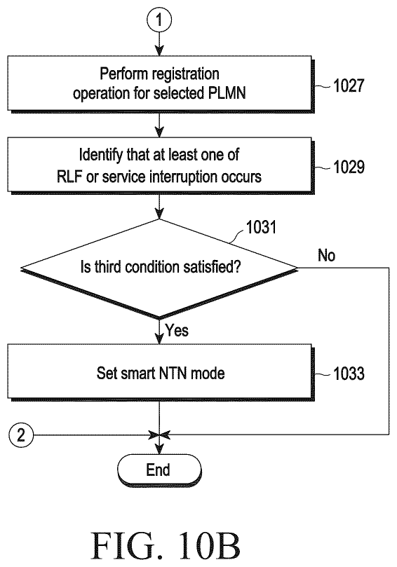

FIGS. 10A and 10B are flowcharts illustrating a method of operating an electronic device, according to an embodiment.

Before describing FIGS. 10A and 10B, an operation of an electronic device (e.g., an electronic device 101 in FIG. 1, FIG. 2, FIG. 3, FIG. 4, or FIG. 5) (e.g., a processor 120 in FIG. 1 or a processor 211 in FIG. 2) illustrated in FIGS. 10A and 10B may be an operation of an electronic device which does not support a user interface (UI) and/or a user experience (UX). For example, the electronic device (e.g., the electronic device 101 in FIG. 1, FIG. 2, FIG. 3, FIG. 4, or FIG. 5) may be a device which does not input a selection for a menu related to an NTN from a user. For example, the electronic device (e.g., the electronic device 101 in FIG. 1, FIG. 2, FIG. 3, FIG. 4, or FIG. 5) may be a device without a display.

Referring to FIGS. 10A and 10B, the electronic device (e.g., the electronic device 101 in FIG. 1, FIG. 2, FIG. 3, FIG. 4, or FIG. 5) (e.g., the processor 120 in FIG. 1 or the processor 211 in FIG. 2) may, in operation 1011, perform a PLMN search operation via at least one communication circuit (e.g., a communication module 190 in FIG. 1 or a communication circuit 215 in FIG. 2). In an embodiment, the electronic device may perform the PLMN search operation if the electronic device is not registered with a PLMN.

The electronic device which performs the PLMN search operation may, in operation 1013, select a PLMN based on a result of the PLMN search operation. By performing the PLMN search operation, the electronic device may find at least one PLMN and select a PLMN for which a registration operation will be performed among the at least one found PLMN. For example, the electronic device may select the PLMN for which the registration operation will be performed among the at least one found PLMN based on a PLMN selection operation specified in V18.3.2 of TS 23.122 of 3GPP.

The electronic device which selects the PLMN may identify, in operation 1015, whether a smart NTN mode is set and whether there is a connection based on an RAT of non-3GPP. In an embodiment, the smart NTN mode may be a mode set to skip a registration operation for at least one PLMN of the NTN. In an embodiment, the smart NTN mode may be a mode set to limitedly activate the NTN. In an embodiment, the smart NTN mode may be implemented to be similar to or substantially the same as described in FIGS. 7A and 7B, so a detailed description thereof will be omitted herein. However, since the operation of the electronic device described in FIGS. 10A and 10B is an operation if the UI and/or UX are not supported, if the smart NTN mode is set to skip the registration operation for the at least one PLMN corresponding to this, the registration operation for the PLMN of the NTN selected by the electronic device may be skipped if a fourth condition, not the first condition, is satisfied. In an embodiment, the fourth condition may include a condition in which there is no data traffic transmission/reception during set time.

As an identification result in operation 1015, if the menu related to the NTN is set and there is the connection based on the RAT of the non-3GPP RAT (Operation 1015—Yes), the electronic device may identify, in operation 1017, whether the selected PLMN is a PLMN of the NTN. In an embodiment, the NTN may include a satellite network. The operation of identifying whether the selected PLMN is the PLMN of the NTN may be implemented to be similar to or substantially the same as that described in FIGS. 7A and 7B, so a detailed description thereof will be omitted herein.

As an identification result in operation 1017, if the selected PLMN is the PLMN of the NTN (Operation 1017—Yes), the electronic device may identify, in operation 1019, whether the fourth condition is satisfied. In an embodiment, the fourth condition may include a condition in which there is no data traffic transmission/reception during the set time. The fourth condition may be similar to the first condition, but may not include a condition in which there is no user input during set time, considering that the electronic device does not support the UI and/or the UX.

As an identification result in operation 1019, if the fourth condition is satisfied (Operation 1019—Yes), the electronic device may, in operation 1021, skip the registration operation for the selected PLMN and provide a limited service until the next PLMN search operation. The limited service may be implemented to be similar to or substantially the same as that described in FIGS. 7A and 7B, so a detailed description thereof will be omitted herein. Skipping the registration operation for the selected PLMN may mean not performing the registration operation for the selected PLMN, and this may be implemented to be similar to or substantially the same as that described in FIGS. 7A and 7B, so a detailed description thereof will be omitted herein.

The electronic device which skips the registration operation for the selected PLMN may identify whether a fifth condition is satisfied in operation 1023. In an embodiment, the fifth condition may include a condition in which there is data traffic transmission/reception and there is no connection based on the RAT of the non-3GPP. As described in operation 1019, in a state in which the fourth condition is satisfied, the electronic device may identify again whether the fifth condition is satisfied in operation 1023. For example, the fifth condition may be a condition for identifying whether there is data traffic transmission/reception again and a connection based on a wireless RAT of the non-3GPP is released in a state in which there is no data traffic transmission/reception during the set time. In an embodiment, operation 1023 may be performed during set time, and the set time used in operation 1023 may be identical to or different from the set time for the fourth condition.

As an identification result in operation 1023, if the fifth condition is not satisfied (Operation 1023—No), the electronic device may return to operation 1011 and perform the PLMN search operation.

As the identification result in operation 1023, if the fifth condition is satisfied (Operation 1023—Yes), the electronic device may unset the smart NTN mode in operation 1025.

As the identification result in operation 1015, if the smart NTN mode is not set and there is no connection based on the RAT of the non-3GPP RAT (Operation 1015—No), the electronic device may perform the registration operation for the selected PLMN in operation 1027. The electronic device which performs the registration operation for the selected PLMN may identify that at least one of an RLF or a service interruption occurs in operation 1029. The electronic device which identifies that the at least one of the RLF or the service interruption occurs may identify whether a third condition is satisfied in operation 1031. The third condition may include at least one of a condition in which an RLF occurs a first set number of times or more during set time, or a condition in which a service interruption occurs a second set number of times or more during set time. The third condition may be implemented to be similar to or substantially the same as that described in FIG. 6, FIG. 7A, FIG. 7B, or FIG. 9, so a detailed description thereof will be omitted herein.

As an identification result in operation 1031, if the third condition is not satisfied (Operation 1031—No), the electronic device may terminate without performing any further operations.

As the identification result in operation 1031, if the third condition is satisfied (Operation 1031—Yes), the electronic device may set the smart NTN mode in operation 1033.

As the identification result in operation 1017, if the selected PLMN is not the PLMN of the NTN (Operation 1017—No), the electronic device may perform the registration operation for the selected PLMN in operation 1035.

As the identification result in operation 1019, if the fourth condition is not satisfied (Operation 1019—No), the electronic device may perform the registration operation for the selected PLMN in operation 1035.

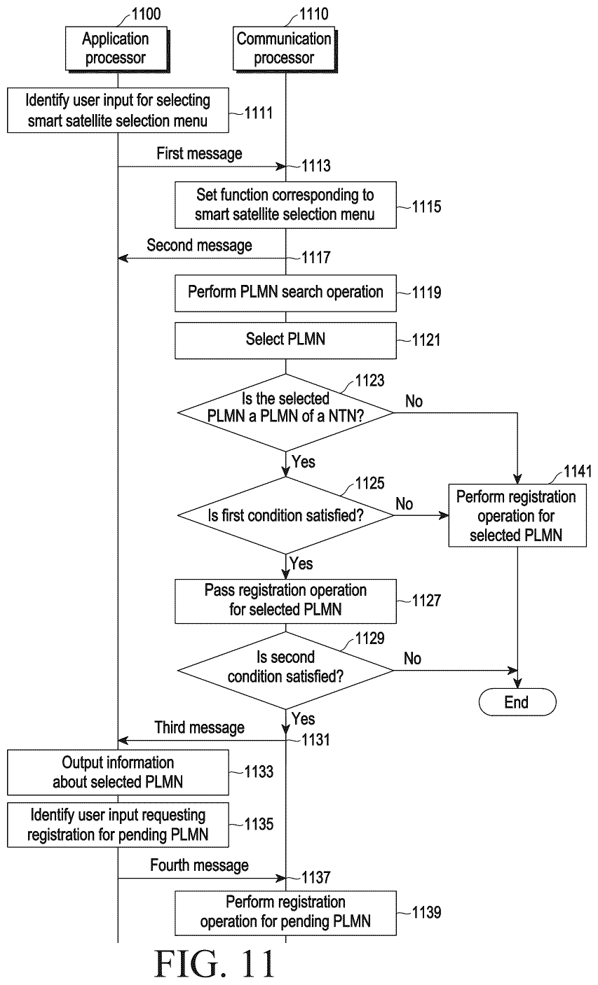

FIG. 11 is a signal flow diagram for describing an operation of an electronic device, according to an embodiment.

Before describing FIG. 11, an operation of an electronic device (e.g., an electronic device 101 in FIG. 1, FIG. 2, FIG. 3, FIG. 4, or FIG. 5) illustrated in FIG. 11 may be described based on a signal flow between an application processor 1100 (e.g., a main processor 121 in FIG. 1) and a communication processor 1110 (e.g., an auxiliary processor 123 in FIG. 1) included in the electronic device. The operation of the electronic device illustrated in FIG. 11 may be an operation in a case that a third menu (e.g., a smart satellite selection menu) for setting a smart NTN mode is selected. Hereinafter, in FIG. 11, for convenience of a description, the third menu for setting the smart NTN mode will be referred to as the “smart satellite selection menu.”

Referring to FIG. 11, the application processor 1100 may identify a user input for selecting (or setting) the smart satellite selection menu in operation 1111. For example, the application processor 1100 may identify the user input for selecting the smart satellite selection menu via a display (e.g., a display 213 in FIG. 2).

The application processor 1100 which identifies the user input for selecting the smart satellite selection menu may transfer a first message requesting the communication processor 1110 to set a function corresponding to the smart satellite selection menu in operation 1113. In an embodiment, the function corresponding to the smart satellite selection menu may include a function corresponding to the smart NTN mode, and the function corresponding to the smart NTN mode may include a function of skipping a registration operation for at least one PLMN of the NTN in a case that a first condition is satisfied.

The communication processor 1110 which receives the first message from the application processor 1100 may set the function corresponding to the smart satellite selection menu in operation 1115.

The communication processor 1110 which sets the function corresponding to the smart satellite selection menu may, in operation 1117, transfer a second message indicating that the function corresponding to the smart satellite selection menu is set in response to the first message. Operation 1117 may be omitted as needed.

In operation 1119, if the communication processor 1110 is not registered with the PLMN, the communication processor 1110 may perform the PLMN search operation. Operation 1119 may be implemented to be similar to or substantially the same as operation 711, so a detailed description thereof will be omitted herein. The communication processor 1110 which performs the PLMN search operation may select a PLMN based on a result of the PLMN search operation in operation 1121. By performing the PLMN search operation, the communication processor 1110 may find at least one PLMN and select a PLMN for which a registration operation will be performed among the at least one found PLMN. Operation 1121 may be implemented to be similar to or substantially the same as operation 713, so a detailed description thereof will be omitted herein.

The communication processor 1110 which selects the PLMN can identify whether the selected PLMN is a PLMN of the NTN in operation 1123. Operation 1123 may be implemented to be similar to or substantially the same as operation 717, so a detailed description thereof will be omitted herein.

As an identification result in operation 1123, if the selected PLMN is the PLMN of the NTN (Operation 1123—Yes), the communication processor 1110 may identify whether a first condition is satisfied in operation 1125. In an embodiment, the first condition may include at least one of a condition in which there is no data traffic transmission/reception during set time, a condition in which there is no user input during set time, or a condition in which there is a connection based on a wireless RAT of non-3GPP. The first condition may be implemented to be similar or substantially the same as that described in FIG. 6, so a detailed description thereof will be omitted herein. Operation 1125 may be implemented to be similar to or substantially the same as operation 719, so a detailed description thereof will be omitted herein.

As an identification result in operation 1125, if the first condition is satisfied (Operation 1125—Yes), the communication processor 1110 may, in operation 1127, skip the registration operation for the selected PLMN and provide a limited service until the next PLMN search operation. Operation 1127 may be implemented to be similar to or substantially the same as operation 721, so a detailed description thereof will be omitted herein.

The communication processor 1110 which skips the registration operation for the selected PLMN may identify whether a second condition is satisfied in operation 1129. In an embodiment, the second condition may include at least one of a condition in which there is data traffic transmission/reception, a condition in which there is a user input, or a condition in which there is no connection based on the RAT of non-3GPP. Operation 1129 may be implemented to be similar to or substantially the same as operation 723, so a detailed description thereof will be omitted herein.

As an identification result in operation 1129, if the second condition is not satisfied (Operation 1129—No), the communication processor 1110 may terminate without performing any further operations.

As the identification result in operation 1129, if the second condition is satisfied (Operation 1129—Yes), the communication processor 1110 may transfer a third message including information about the selected PLMN to the application processor 1100 in operation 1131. In an embodiment, the information about the selected PLMN may include information informing that there is a PLMN which is selected but for which a registration operation is not performed. In an embodiment, the third message may be a service indication message, and the service indication message may include a limited-cause. In an embodiment, the limited-cause may be a parameter indicating a reason for which the limited service is performed, and in FIG. 11, it may be set to “Pending Sta” indicating that the limited service is performed because the selected PLMN is a satellite PLMN (for example, limited-cause: Pending Sta).

The application processor 1100 which receives the third message from the communication processor 1110 may output information about the selected PLMN via the display based on identifying that the second condition is satisfied. In an embodiment, the information about the selected PLMN may be outputted in a form of pop-up, as a guidance message indicating that there is a PLMN which is selected but for which a registration operation is not performed. Hereinafter, for convenience of a description, in FIG. 11, a PLMN which is already selected but for which a registration operation is not performed will be referred to as a “pending PLMN.” In an embodiment, there may be no limitation on a form of outputting the information about the pending PLMN. In an embodiment, there may be no limitation on information included in the information about the pending PLMN. Operation 1133 may be implemented to be similar to or substantially the same as operations 723 and 725, so a detailed description thereof will be omitted herein.

The application processor 1100 which outputs the information about the pending PLMN may identify a user input requesting registration for the pending PLMN (e.g., a satellite PLMN) in operation 1135. In an embodiment, the user input requesting the registration for the pending PLMN (e.g., the satellite PLMN) may be identified via the display.

The application processor 1100 which identifies the user input requesting the registration for the pending PLMN (e.g., the satellite PLMN) may transfer a fourth message requesting the communication processor 1110 to perform the registration operation for the pending PLMN in operation 1137. The communication processor 1110 which receives the fourth message from the application processor 1100 may perform the registration operation for the pending PLMN via a communication circuit (e.g., a communication circuit 215 in FIG. 2) in operation 1139.

As the identification result in operation 1123, if the selected PLMN is not the PLMN of the NTN (Operation 1123—No), the communication processor 1110 may perform the registration operation for the selected PLMN via the communication circuit in operation 1141.

As the identification result in operation 1125, if the first condition is not satisfied (Operation 1125—No), the communication processor 1110 may perform the registration operation for the selected PLMN via the communication circuit in operation 1141.

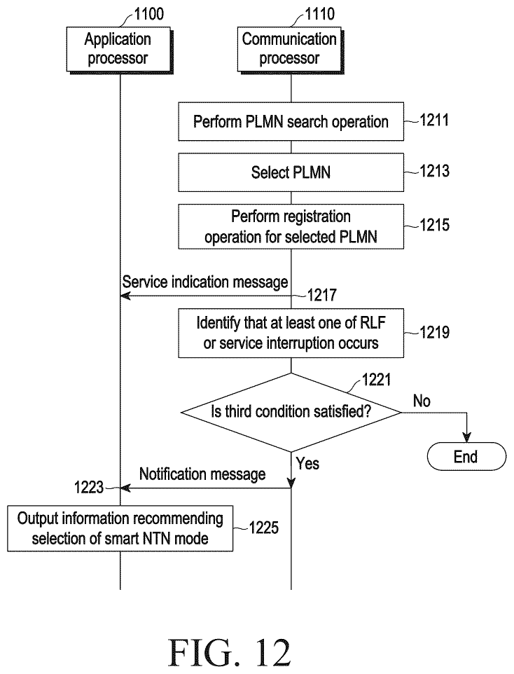

FIG. 12 is a signal flow diagram for describing an operation of an electronic device, according to an embodiment.

Before describing FIG. 12, an operation of an electronic device (e.g., an electronic device 101 in FIG. 1, FIG. 2, FIG. 3, FIG. 4, or FIG. 5) illustrated in FIG. 12 may be described based on a signal flow between an application processor 1100 (e.g., a main processor 121 in FIG. 1 or an application processor 1100 in FIG. 11) and a communication processor 1110 (e.g., an auxiliary processor 123 in FIG. 1 or a communication processor 1110 in FIG. 11) included in the electronic device. The operation of the electronic device illustrated in FIG. 12 may be an operation in a case that a third menu (e.g., a smart satellite selection menu) for setting a smart NTN mode is not selected. Hereinafter, in FIG. 12, for convenience of a description, a menu related to an NTN will be referred to as the “smart satellite selection menu.”

Referring to FIG. 12, in operation 1211, if the communication processor 1110 is not registered with a PLMN, the communication processor 1110 may perform a PLMN search operation. Operation 1211 may be implemented to be similar to or substantially the same as operation 711, so a detailed description thereof will be omitted herein. The communication processor 1110 which performs the PLMN search operation may select a PLMN based on a result of the PLMN search operation in operation 1213. By performing the PLMN search operation, the communication processor 1110 may find at least one PLMN and select a PLMN for which a registration operation will be performed among the at least one found PLMN. Operation 1213 may be implemented to be similar to or substantially the same as operation 713, so a detailed description thereof will be omitted herein.

The communication processor 1110 which selects the PLMN may perform a registration operation for the selected PLMN in operation 1215. Operation 1215 may be implemented to be similar to or substantially the same as operation 727, so a detailed description thereof will be omitted herein.

The communication processor 1110 which performs the registration operation for the selected PLMN may, in operation 1217, transfer, to the application processor 1100, a service indication message indicating that a communication is performed with the selected PLMN.

The communication processor 1110 which transfers the service indication message to the application processor 1100 may identify that at least one of an RLF or a service interruption occurs in operation 1219. Operation 1219 may be implemented to be similar to or substantially the same as operation 729, so a detailed description thereof will be omitted herein.

The communication processor 1110 which identifies that the at least one of the RLF or the service interruption occurs may identify whether a third condition is satisfied in operation 1221. The third condition may include at least one of a condition in which an RLF occurs a first set number of times or more during set time, or a condition in which a service interruption occurs a second set number of times or more during set time. The third condition may be implemented to be similar to or substantially the same as that described in FIG. 6, FIG. 7A, FIG. 7B, or FIG. 9, so a detailed description thereof will be omitted herein. Operation 1221 may be implemented to be similar to or substantially the same as operation 731, so a detailed description thereof will be omitted herein.

As an identification result in operation 1221, if the third condition is not satisfied (Operation 1221—No), the communication processor 1110 may terminate without performing any further operations.

As the identification result in operation 1221, if the third condition is satisfied (Operation 1221—Yes), the communication processor 1110 may transfer a notification message to the application processor 1100 in operation 1223. In an embodiment, the notification message may include information recommending selection of the smart NTN mode. The information recommending the selection of the smart NTN mode may be implemented to be similar to or substantially the same as that described in FIG. 6, FIG. 7A, FIG. 7B, or FIG. 9, so a detailed description thereof will be omitted herein.

The application processor 1100 which receives the notification message from the communication processor 1110 may output the information recommending the selection for the smart NTN mode via a display (e.g., a display 213 in FIG. 2) in operation 1225. In an embodiment, the information recommending the selection for the smart NTN mode may be outputted in a pop-up form, and there may be no limitation on a form of outputting the information recommending the selection for the smart NTN mode.

According to an embodiment of the disclosure, a method may comprise performing a public land mobile network (PLMN) search operation via the at least one communication circuit.

According to an embodiment of the disclosure, the method may comprise selecting a PLMN based on a result of the PLMN search operation.

According to an embodiment of the disclosure, the method may comprise identifying whether the selected PLMN is a PLMN of a non-terrestrial network (NTN).

According to an embodiment of the disclosure, the method may comprise, based on identifying that the selected PLMN is the PLMN of the NTN, identifying whether a first condition is satisfied.

According to an embodiment of the disclosure, the method may comprise, based on identifying that the first condition is satisfied, skipping a registration operation for the selected PLMN.

According to an embodiment of the disclosure, the method may comprise, based on identifying that the first condition is not satisfied, performing the registration operation for the selected PLMN.

According to an embodiment of the disclosure, the method may comprise, after skipping the registration operation for the PLMN selected, identifying whether a second condition is satisfied.

According to an embodiment of the disclosure, the method may comprise, based on identifying that the second condition is satisfied, displaying information about the selected PLMN.

According to an embodiment of the disclosure, the method may comprise, before performing the PLMN search operation, identifying a user input for selecting a menu for setting a mode in which a registration operation for at least one PLMN of the NTN is skipped.

According to an embodiment of the disclosure, the method may comprise, setting the mode based on the user input.

According to an embodiment of the disclosure, the method may comprise, after skipping the registration operation for the selected PLMN, identifying whether a second condition is satisfied.

According to an embodiment of the disclosure, the method may comprise, based on identifying that the second condition is satisfied, returning to the operation of performing the PLMN search operation.

According to an embodiment of the disclosure, the method may comprise, before returning to the operation of performing the PLMN search operation based on identifying that the second condition is satisfied, releasing the setting for the mode.

According to an embodiment of the disclosure, the method may comprise, after selecting the PLMN, identifying whether a mode in which a registration operation for at least one PLMN of the NTN is skipped is set.

According to an embodiment of the disclosure, the method may comprise, based on identifying that the mode is not set, performing the registration operation for the selected PLMN.

According to an embodiment of the disclosure, the method may comprise, after performing the registration operation for the selected PLMN, identifying whether a third condition is satisfied).

According to an embodiment of the disclosure, the method may comprise, based on identifying that the third condition is satisfied, outputting information for recommending selection of the mode.

According to an embodiment of the disclosure, the first condition may include at least one of a condition in which there is no data traffic transmission/reception by the at least one processor during set time, a condition in which there is no user input during the set time, or a condition in which there is a connection based on a radio access technology (RAT) of a non-3rd generation partnership project (non-3GPP).

According to an embodiment of the disclosure, the second condition may include at least one of a condition in which there is data traffic transmission/reception by the at least one processor, a condition in which there is a user input, or a condition in which there is no connection based on a radio access technology (RAT) of a non-3rd generation partnership project (non-3GPP).

According to an embodiment of the disclosure, the method may comprise, based on identifying that the first condition is not satisfied, performing the registration operation for the selected PLMN.

According to an embodiment of the disclosure, a storage medium storing at least one computer-readable instruction may be provided.

According to an embodiment of the disclosure, the at least one instruction, when executed by at least one processor (120; 211) of an electronic device (101), may cause the electronic device to perform at least one operation.

According to an embodiment of the disclosure, the at least one operation may comprise performing a public land mobile network (PLMN) search operation.

According to an embodiment of the disclosure, the at least one operation may comprise selecting a PLMN based on a result of the PLMN search operation.

According to an embodiment of the disclosure, the at least one operation may comprise identifying whether the selected PLMN is a PLMN of a non-terrestrial network (NTN).

According to an embodiment of the disclosure, the at least one operation may comprise, based on identifying that the selected PLMN is the PLMN of the NTN, identifying whether a first condition is satisfied.

According to an embodiment of the disclosure, the at least one operation may comprise, based on identifying that the first condition is satisfied, skipping a registration operation for the selected PLMN.

What is claimed is:

1. An electronic device comprising:
at least one communication circuit;
at least one processor operably connected to the at least one communication circuit; and
memory storing instructions, wherein the instructions, when executed by the at least one processor individually or collectively, cause the electronic device to:
perform a public land mobile network (PLMN) search operation via the at least one communication circuit,
select a PLMN based on a result of the PLMN search operation,
identify whether the selected PLMN is a PLMN of a non-terrestrial network (NTN),
based on identifying that the selected PLMN is the PLMN of the NTN, identify whether a first condition is satisfied, and
based on identifying that the first condition is satisfied, skip a registration operation for the selected PLMN.

2. The electronic device of claim 1, wherein the instructions, when executed by the at least one processor individually or collectively, cause the electronic device to:
based on identifying that the first condition is not satisfied, perform the registration operation for the selected PLMN via the at least one communication circuit.

3. The electronic device of claim 1, the electronic device further comprising:
a display,
wherein the instructions, when executed by the at least one processor individually or collectively, cause the electronic device to:
after skipping the registration operation for the selected PLMN, identify whether a second condition is satisfied, and
based on identifying that the second condition is satisfied, display information about the selected PLMN via the display.

4. The electronic device of claim 1, wherein the instructions, when executed by the at least one processor individually or collectively, cause the electronic device to:
before performing the PLMN search operation, identify a user input for selecting a menu for setting a mode in which the registration operation for at least one PLMN of the NTN is skipped, and
set the mode based on the user input.

5. The electronic device of claim 4, wherein the instructions, when executed by the at least one processor individually or collectively, cause the electronic device to:
after skipping the registration operation for the selected PLMN, identify whether a second condition is satisfied, and
based on identifying that the second condition is satisfied, perform the PLMN search operation.

6. The electronic device of claim 5, wherein the instructions, when executed by the at least one processor individually or collectively, cause the electronic device to:
before performing the PLMN search operation based on identifying that the second condition is satisfied, release the setting for the mode.

7. The electronic device of claim 1, further comprising:
a display,
wherein the instructions, when executed by the at least one processor individually or collectively, cause the electronic device to:
after selecting the PLMN, identify whether a mode in which the registration operation for at least one PLMN of the NTN is skipped is set,
based on identifying that the mode is not set, perform the registration operation for the selected PLMN via the at least one communication circuit,
after performing the registration operation for the selected PLMN, identify whether a third condition is satisfied, and
based on identifying that the third condition is satisfied, output information for recommending selection of the mode via the display.

8. The electronic device of any one of claim 1, wherein the first condition comprises at least one of:
a condition in which there is no data traffic transmission/reception by the at least one processor during a set time,
a condition in which there is no user input during the set time, or
a condition in which there is a connection based on a radio access technology (RAT) of a non-3rd generation partnership project (non-3GPP).

9. The electronic device of claim 3, wherein the second condition comprises at least one of:
a condition in which there is data traffic transmission/reception by the at least one processor,
a condition in which there is a user input, or
a condition in which there is no connection based on a radio access technology (RAT) of a non-3rd generation partnership project (non-3GPP).

10. The electronic device of claim 1, wherein the instructions, when executed by the at least one processor individually or collectively, cause the electronic device to:
based on identifying that the first condition is not satisfied, perform the registration operation for the selected PLMN via the at least one communication circuit.

11. A method comprising:
performing a public land mobile network (PLMN) search operation;
selecting a PLMN based on a result of the PLMN search operation;
identifying whether the selected PLMN is a PLMN of a non-terrestrial network (NTN);
based on identifying that the selected PLMN is the PLMN of the NTN, identifying whether a first condition is satisfied; and
based on identifying that the first condition is satisfied, skipping a registration operation for the selected PLMN.

12. The method of claim 11, further comprising:
based on identifying that the first condition is not satisfied, performing the registration operation for the selected PLMN.

13. The method of claim 11, further comprising:
after skipping the registration operation for the PLMN selected, identifying whether a second condition is satisfied; and
based on identifying that the second condition is satisfied, displaying information about the selected PLMN.

14. The method of claim 11, further comprising:
before performing the PLMN search operation, identifying a user input for selecting a menu for setting a mode in which the registration operation for at least one PLMN of the NTN is skipped; and
setting the mode based on the user input.

15. A non-transitory computer-readable recording medium storing at least one computer-readable instruction, the at least one instruction, when executed by at least one processor of an electronic device individually or collectively, causes the electronic device to:
perform a public land mobile network (PLMN) search operation;
select a PLMN based on a result of the PLMN search operation;
identify whether the selected PLMN is a PLMN of a non-terrestrial network (NTN);
based on identifying that the selected PLMN is the PLMN of the NTN, identifying whether a first condition is satisfied; and
based on identifying that the first condition is satisfied, skipping a registration operation for the selected PLMN.

16. The non-transitory computer-readable recording medium of claim 15, wherein the at least one instruction, when executed by the at least one processor individually or collectively, causes the electronic device to:
based on identifying that the first condition is not satisfied, perform the registration operation for the selected PLMN.

17. The non-transitory computer-readable recording medium of claim 15, wherein the at least one instruction, when executed by the at least one processor individually or collectively, causes the electronic device to:
after skipping the registration operation for the selected PLMN, identify whether a second condition is satisfied, and
based on identifying that the second condition is satisfied, display information about the selected PLMN.

18. The non-transitory computer-readable recording medium of claim 15, wherein the at least one instruction, when executed by the at least one processor individually or collectively, causes the electronic device to:
before performing the PLMN search operation, identify a user input for selecting a menu for setting a mode in which the registration operation for at least one PLMN of the NTN is skipped, and
set the mode based on the user input.

19. The non-transitory computer-readable recording medium of claim 18, wherein the at least one instruction, when executed by the at least one processor individually or collectively, causes the electronic device to:
after skipping the registration operation for the selected PLMN, identify whether a second condition is satisfied, and
based on identifying that the second condition is satisfied, perform the PLMN search operation.

20. The non-transitory computer-readable recording medium of claim 19, wherein the at least one instruction, when executed by the at least one processor individually or collectively, causes the electronic device to:
before performing the PLMN search operation based on identifying that the second condition is satisfied, release the setting for the mode.
